(19) United States
(12) Patent Application Publication
(10) Pub. No.: US 2016/0379251 A1
(43) Pub. Date: Dec. 29, 2016

(54) TARGETED ADVERTISING USING A DIGITAL SIGN

(71) Applicant: Intel Corporation, Santa Clara, CA (US)

(72) Inventors: Addicam V. Sanjay, Gilbert, AZ (US); Archana Rajendran, Tempe, AZ (US); Jose A. Avalos, Chandler, AZ (US); Lakshman Krishnamurthy, Portland, OR (US); Mary C. Murphy-Hoye, Phoenix, AZ (US); Miriam Daniel, Cupertino, CA (US); Rajnish Maini, Chandler, AZ (US)

(73) Assignee: Intel Corporation, Santa Clara, CA (US)

(21) Appl. No.: 14/752,471

(22) Filed: Jun. 26, 2015

(51) Int. Cl. G06Q 30/02; H04W 4/02; H04W 4/00; G06Q 50/00; G06F 17/30

(52) U.S. Cl. CPC G06Q 30/0255; G06Q 30/0261; G06Q 30/0267; G06Q 50/01; G06F 17/30539; G06F 17/30867; H04W 4/008; H04W 4/02

(57) ABSTRACT

Disclosed herein is a computer system for rendering targeted advertisements. The computer system includes a Web crawling module that generates product information based on product reviews obtained from product review Websites. The computer system also includes a content management module that receives audience metrics and user interest data from a digital sign. The audience metrics describe features of people in the vicinity of the digital sign, and the user interest data is received from a mobile device in the vicinity of the digital sign. The computer system also includes a data miner to correlate the product information, the user interest data, and the audience metrics to identify an advertisement likely to appeal to the user of the mobile device.

### TECHNICAL FIELD

The present disclosure relates to techniques for generating targeted advertising based on information gathered from a variety of sources, including a digital sign.

### BACKGROUND ART

The term “digital signage” generally refers to the use of electronic display devices to provide advertising, announcements, or other types of information to the public. Digital signage is often displayed in public venues such as restaurants, shopping malls, sporting arenas, amusement parks, and the like. Digital signage enables advertisers to display advertising content that is more engaging and dynamic. The advertisers can also easily change the content in real time based on changing conditions, such as the availability of new promotions, the time of day, weather conditions, and other data. In this way, advertising content can be more effectively targeted to the specific demographics of the people viewing it.

### BRIEF DESCRIPTION OF THE DRAWINGS

FIG. 1 is a block diagram of a system for generating targeted advertising.

FIG. 2 is an example of a system that can be implemented in the mobile device of FIG. 1.

FIG. 3 is a block diagram showing an example implementation of the system described in FIG. 1.

FIGS. 4A-4D show a process flow diagram for a method of generating targeted advertising.

FIG. 5 is a process flow diagram summarizing a method of generating targeted advertising.

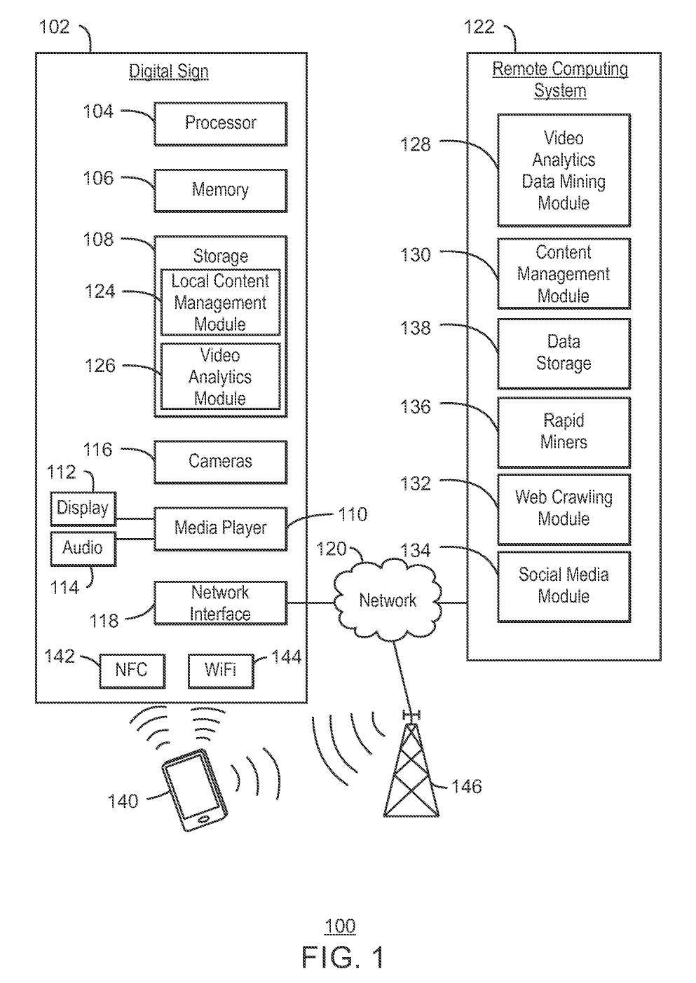

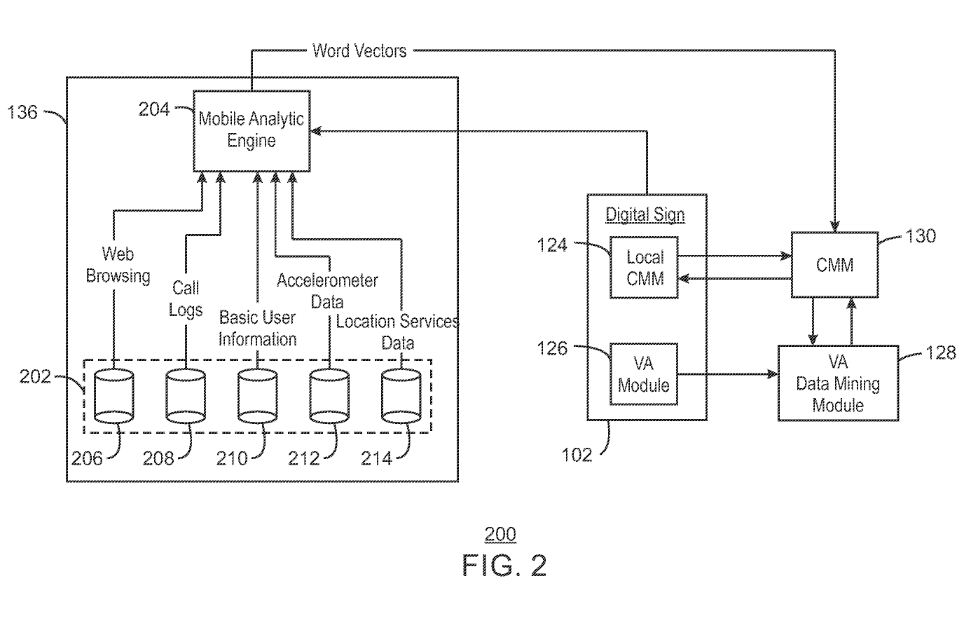

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The present disclosure provides techniques for generating targeted advertising using a digital sign. The digital sign can be used to gather demographic information about the people in the vicinity of the digital sign. The demographic information can be combined with user interest information gathered from a variety of sources. For example, some user interest information can be gathered from a smart phone, or other mobile device, in the vicinity of the digital sign. User interest information can be pushed from the smart phone anonymously, in other words, without revealing the identity of the smart phone user. User interest information can also be generated based on information gathered from the Internet, such as social media and shopping Websites. Using these sources of information, the system can select an advertisement that will have a high likelihood of appealing to the target audience members. The selected advertisement can be pushed to a person's smart phone or the digital sign.

FIG. 1 is a block diagram of a system for generating targeted advertising. The system 100 includes a digital sign 102. The digital sign 102 may configured to present any type of content, menu items, advertisements, train schedule or flight status information, pricing information, entertainment, music, and others. The digital sign may be deployed in any type of setting, including a restaurant, a shopping mall, sports arena, or airport, for example.

The digital sign 102 includes a processor 104 that is adapted to execute stored instructions, as well as a memory 106 that stores instructions that are executable by the processor 104. The processor 104 can be a single core processor, a multi-core processor, or any number of other configurations. The memory 106 can include random access memory (RAM), such as Dynamic Random Access Memory (DRAM), or any other suitable memory type. The memory 106 can be used to store data and computer-readable instructions that, when executed by the processor, direct the processor to perform various operations in accordance with embodiments described herein.

The digital sign 102 can also include a storage device 108. The storage device 108 is a physical memory such as a hard drive, an optical drive, a solid-state drive, an array of drives, or any combinations thereof. The storage device 108 may also include remote storage devices. Content to be rendered by the digital sign, such as audio, video, and image files, may be stored to the storage device 108.

The digital sign 102 also includes a media player 110, a display 112, and an audio system 114. The display 112 may be any suitable type of display type, including Liquid Crystal Display (LCD), Organic Light Emitting Diode (OLED), Plasma, and others. In some examples, the digital signs can include multiple displays, each of which may be configured to display the same content or different content. The display 112 and the audio system 114 may be built-in components of the digital sign 102 or externally coupled to the digital sign 102.

The digital sign 102 can also include one or more cameras 116 configured to capture still images or video. The cameras 116 may be built-in components of the digital sign 102 or externally coupled to the digital sign 102. Images or video captured by the camera 116 can be analyzed by one or more programs executing on the digital sign 102 to generate various information about people in the vicinity of the digital sign 102.

In some examples, the digital sign 102 includes a network interface 118 configured to connect the digital sign through to a network 120. The network 120 may be a wide area network (WAN), local area network (LAN), or the Internet, among others. Through the network, the digital sign 102 can connect to a remote computing system 122. The remote computing system 122 can include various modules used to identify content to be rendered by the digital sign 102. The remote computing system 122 can include any suitable type of computing system, including one or more desktop computers, server computers, or a cloud computing system, for example. The modules may be programming modules to be executed by one or more processors. The modules may also be implemented as other types of computing hardware such as Application Specific Integrated Circuits (ASICs), and others.

Together, the digital sign 102 and the remote computing system 122 coordinate to identify characteristics and possible interests of the people in the vicinity of the digital sign and then identify targeted advertisements intended to appeal to one or more people in the vicinity of the digital sign 102. The digital sign 102 can include various programming modules to enable it to identify characteristic of people and coordinate the rendering of media content, including a local content management module 124 and a video analytics module 126. The video analytics module 126 analyzes images captured by the cameras 116 and generates information about the people in the vicinity of the display. The information generated by the video analytics module 126 about the people in the vicinity of the display is referred to herein as audience metrics. The video analytics module 126 can identify people, determine whether a person is male or female, and determine an approximate age of a person. The audience metrics can include information such as the number of people in the vicinity of the digital sign 102 and the mix of ages and genders in the vicinity of the digital sign 102.

Based on the audience metrics generated by digital sign 102, advertisements can be identified that have a greater likelihood of appealing to a large portion of the audience. For example, the identified content may be an advertisement for a particular offering that has been determined to appeal to a certain age group. The advertisement can include visual content that is displayed on a portion the display 112 and/or audio content that is played through the audio system 114. The audience metrics captured by the video analytics module 126 can be sent to the remote computing system 122 via the network 120 for further analysis. The analysis of audience metrics and selection of content can be performed by the digital sign 102, by the remote computing system 122, or some combination thereof.

The local content management module 124 coordinates the rendering of content by the digital sign 102 and can record information about what content was rendered, the time of day that the content was rendered, the duration of the content rendering, and the like. This information about the rendered contents can be referred to herein as playlist information. The local content management module 124 can send the playlist information to the remote computing system 122 via the network for further analysis.

The remote computing system 122 receives the audience metrics and the playlist information and uses the data, in conjunction with other data, to generate advertisement recommendations. In some examples, the remote computing system 122 includes a video analytics data mining module 128, a content management module 130, a Web crawling module 132, a Social Media module 134, and one or more rapid miners 140. The remote computing system 122 may also include or be coupled to a data storage system 142 for the long-term storage of data.

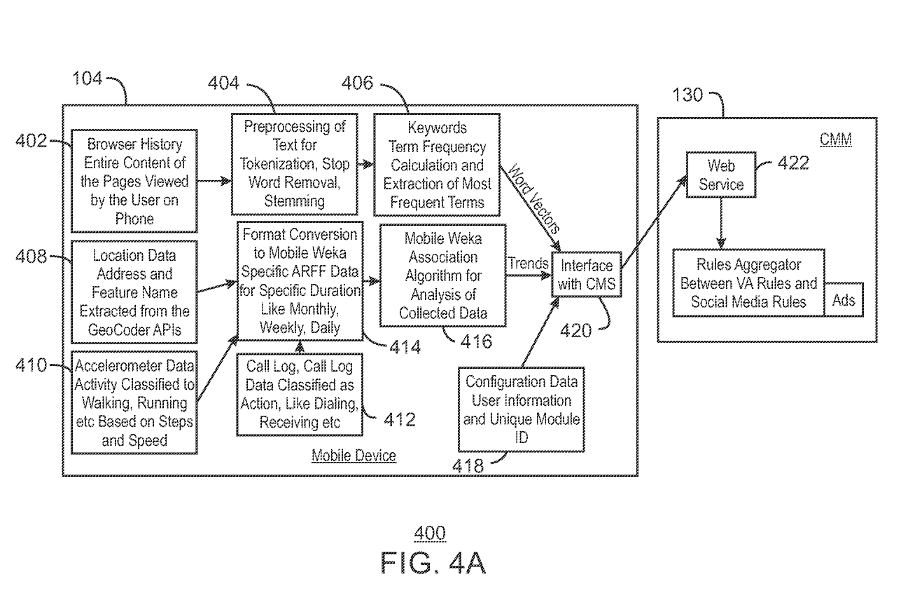

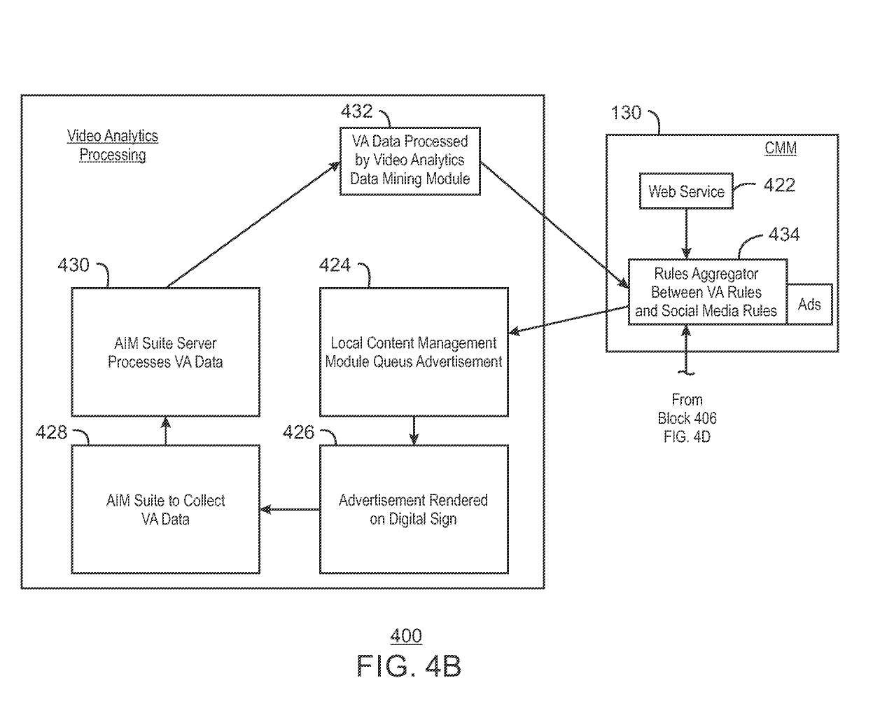

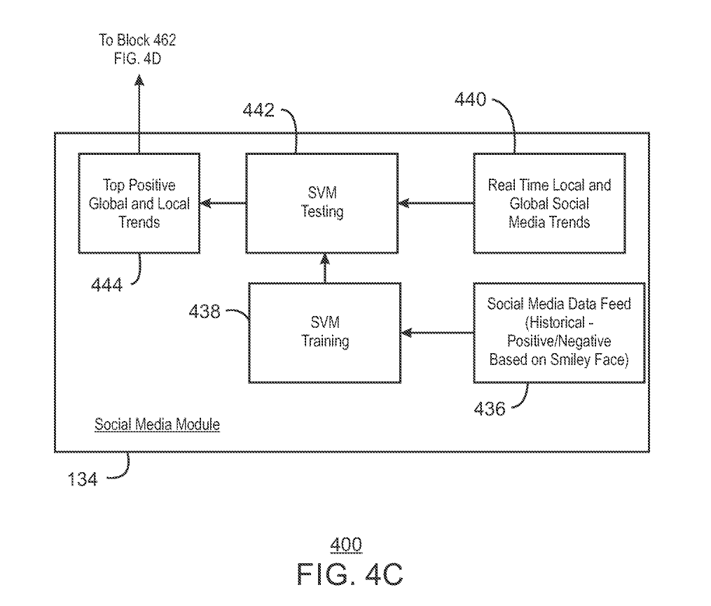

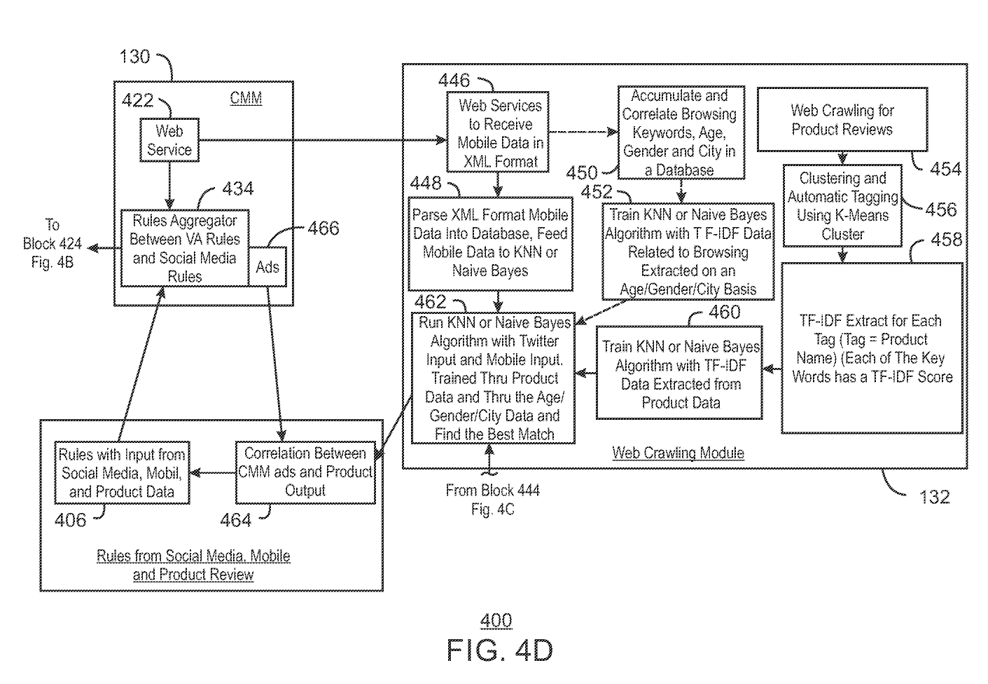

The content management module 130 communicates with the local content management module 124 on the digital sign 102. For example, the content management module 130 can send content recommendations to the local content management module 124. A content recommendation can include an identification of a media file to be rendered, a location of the rendering, and other information. The local content management module 124 can render the recommended content immediately or place the recommended content in a queue for future rendering. The content management module can also coordinate the communications between other components of the remote computing system 122, as described further in relation to FIGS. 4A-4D.

The video analytics data mining module 128 receives the playlist data from the local content management module 124 and also receives the audience metrics from the video analytics module 126. The video analytics data mining module 128 can then analyze the information to generate video analytics rules based on statistical correlations between the rendered content and the audience metrics. For example, a specific advertisement may be of more interest to younger males. Analysis of the audience metrics may indicate that during the rendering of the advertisement, the majority of people viewing the advertisement are young and male. Such correlations can be used by the video analytics data mining module 128 to generate video analytics rules. To continue with the above example, the video analytics data mining module 128 may generate a rule that states the advertisement should be shown during a certain time of day, or when the current audience is composed of a certain number or certain percentage of young males, or some combination of the time of day and the audience composition. The video analytics data mining module 128 may also identify similar content and create video analytics rules that refer to the similar content. For example, a rule may identify a range of media files.

The video analytics data mining module 128 can send the video analytics rules to the content management module 130. The content management module 130 can monitor the current audience metrics received from the video analytics module 126 and identify content to be rendered based at least in part on the video analytics rules. In some examples, the content to be rendered may be an advertisement intended to be of interest to a particular segment of the people in the vicinity of the sign.

In some examples, the video analytics data mining module 128 can send the video analytics rules to the content management module 130. The content management module 130 correlates the video analytics rules with additional rules generated by data mining other sources such as data received from a user's mobile device, product Websites, and social media feeds to determine content to be rendered by the digital sign 102. The acquired audience metrics, playlist data, and video analytics rules generated by the video analytics data mining module 128 may be stored to a data storage system 132. The data storage system can include any suitable non-volatile memory system for the long-term storage of data, such as an array of hard disks, solid state memory devices, tape drives, and others. In some examples, media content may also be stored to the data storage system 132 and transferred to the digital sign 102.

The Web crawling module 132 searches Websites to identify potential user interests. For example, the Web crawling module 132 can search websites in which users express an opinion about particular products and services. Such Websites could include shopping Websites, reviewer Websites, blogs, and others. The Web crawling module 132 can generate product information, which may include a list of products and a level of general user interest, and/or a product rating, for each product.

The social media module 134 can receive a live data from one or more a Web based social media services such as Facebook, Twitter, and one or more Rich Site Summary (RSS) feeds. The social media module 134 can analyze the data to identify current social trends, which are particular topics of interest to a large number of people. For example, the social media module 134 may identify a particular musical artist or movie as generating a large amount of commentary. The product information generated by the Web crawling module 132 and/or the social trend information generated by the social media module 134 can be used by the content management module 130 as an additional input for identifying the targeted advertisements.

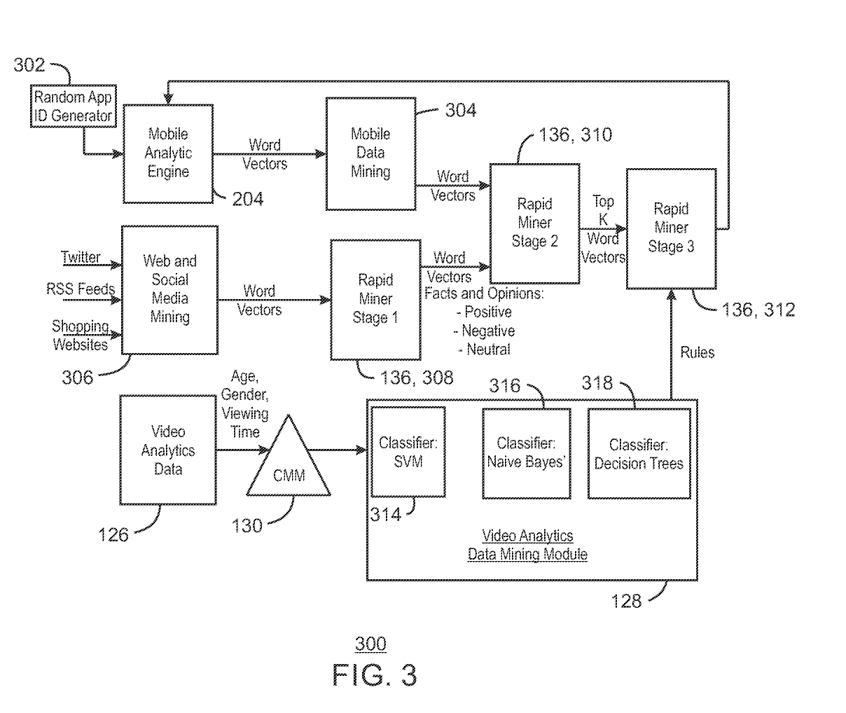

The rapid miners 136 are data miners configured to correlate the product information, the user interest data, and the audience metrics to identify an advertisement likely to appeal to the user of the mobile device. The rapid miners are 136 are described further in relation to FIG. 3.

The system 100 can also be configured to receive data from one or more mobile devices 140, which may be smart phones, tablets, laptop computers, and the like. The digital sign 102 can include an NFC interface 142 and/or a WiFi interface 144 for communicating with the mobile devices 140. The mobile device 140 can also connect to the network 120 through a cellular network 146. Communication between the mobile device 140, the digital sign 102, and the remote computing system 122 can occur through the WiFi interface 144 of the digital sign 102, or through the cellular network 146, or some combination thereof.

The presence of the mobile device 140 can be detected by the digital sign 102 through the NFC interface 142 or the WiFi interface 144. Detecting the presence of the mobile device 140 in the vicinity of the digital sign 102 can trigger the mobile device 140 to send user interest data to the digital sign 102 and/or to the remote computing system 122. An operating system or application running on the mobile device 140 may trigger the sending of the user interest data upon detection of the digital sign 102, or the digital sign 102 may request the user interest data. In some examples, a random number is generated and used by the mobile device 140 as an anonymous device identifier that can be used by the system 100 to target the mobile device with targeted advertisements without actually knowing the personal identity of the mobile device's user. The random number may be generated by the digital sign 102 and transmitted to the mobile device 140. Furthermore, the user interest data is generated by the mobile device 102 and does not include any information that could be used to identify the user of the mobile device 102. Detecting the presence of the mobile device 140 also informs the digital sign 102 regarding the user's current location, which can be used to render the targeted advertising to the digital sign102 at the user's location.

The user interest data received from the mobile device 140 can be used by the content management module 130 as an additional input for identifying the targeted advertisements. The targeted advertisements may be rendered on the digital sign 102, or the mobile device 140, or both. In some examples, one part of an advertisement may be pushed to the digital sign 102 and another complimentary part of the advertisement may be rendered on the mobile device 140.

In some examples, a user may interact with the digital sign 102 using the mobile device 140 to accept an offer or make a purchase. For example, the advertisement being displayed on the digital sign or the mobile device 140 may make an offer for sale of a product, a special discount on a product, or other offers. The user may accept the offer by completing a purchase, downloading a coupon, and the like. In the case of a purchase made through the digital sign 102, the mobile device 140 may communicate the purchase information from the mobile device 140 to the digital sign 102 through the NFC interface 142.

It will be appreciated that the particular system shown in FIG. 1 is an example implementation of the techniques disclosed herein, and that other implementations are also possible. For example, in some implementations, one or more of the video analytics data mining module 128, the video analytics data mining module 128, the content management module 130, and the data storage system 132 may reside locally on the digital sign 102. Examples of particular implementations of the system 100 are described in more detail below.

FIG. 2 is an example of a system that can be implemented in the mobile device of FIG. 1. The mobile device 140 of FIG. 2 includes data storage 202 and a mobile analytics engine 204. The data stored to the data storage 202 can include Web browsing data 206, call log data 208, basic user information 210, accelerometer data 212, and location services data 214. Some or all of this information can be sent to the mobile analytics engine 204 and used to generate user interest information. For example, the Web browsing data 206 can be analyzed to identify search terms entered by the user, Web sites visited, and other data. The location services data 214 can be used to determine recent and frequently visited locations. Such information may be used to identify favorite activities or favorite restaurants for example. Some data may be used as an indication of the user's personality. For example, the call log data 208 can be used to as an indication about the user's level of social interaction, and the accelerometer data may be used as an indication of the user's physical activity level or level of athleticism. The basic user information can include information such as the type of mobile device, device configuration, and the unique mobile device identifier.

The mobile analytics engine 204 processes the information to generate anonymous user interest information. The user interest information is described as anonymous because it does not reveal the identity of the user of the mobile device. In some examples, the user interest information is represented as one or more word vectors. The user interest information can be sent to the content management module 130, which can forward some or all of the user interest information to the video analytics data mining module 128. Although shown as being sent directly to the content management module 130, the user interest information can be sent to the content management module 130 through the digital sign 102, or through a cellular network, etc.

The video analytics module 126 collects audience as described above in relation to FIG. 1 and sends the audience information to the video analytics data mining module 128. The video analytics data mining module 128 uses the audience information and the user interest information to generate the video analytics rules that help to determine the next advertisement to be shown by the digital sign 102. The video analytics rules are sent to the content management module 130, which selects an advertisement based on the video analytics rules. The selected advertisement is sent to the local content management module 124 on the digital sign 102. The local content management module 124 also sends data back to the content management module 130 regarding what advertisements were rendered and when.

FIG. 3 is a block diagram showing an example implementation of the system described in FIG. 1. In the example implementation of FIG. 3, the mobile analytic engine receives an application identifier (app ID) from the app ID generator 302. The app ID generator 302 can reside on the digital sign 102. As described above, the mobile analytic engine 204 generates user interest information, which may be represented as one or more word vectors. In some examples, the word vectors are sent to a mobile data mining engine 304 that resides on the remote computing system 122 (FIG. 1). The data mining engine 304 may be the Waikato Environment for Knowledge Analysis (Weka) machine learning software.

The Web and social media mining data 306 represents the data generated by the Web crawling module 132 and the social media module 134 shown in FIG. 1. As shown in FIG. 3, the inputs to these modules include RSS feeds, shopping Websites, and a social media feed such as a Twitter feed. These sources of information are processed to obtain user interests of a large number of people, which may be represented as one or more additional word vectors. The word vectors generated from the Web and social media mining data 306 are sent to a first stage Rapid miner 308.

The word vectors from the mobile data mining engine 304 and the word vectors from the first stage rapid miner 308 are sent to the second stage rapid miner 310. The second stage rapid miner 310 compares combines both sets of input word vectors and generates as output a set of the top word vectors common to both the mobile user interest data and the Web and social media data.

As described above, the video analytics data from the digital sign 126 is sent to the content management module 130 and processed by the video analytics data mining module 128. The video analytics data mining module 128 can include a variety of machine learning tools. As shown in FIG. 3, the video analytics data mining module 128 can include a number of classifiers, including a support vector machine (SVM) 314, a naive Bayes classifier 316, and a decision tree 318.

The word vectors from the second stage rapid miner 310 and the video analytics rules generated by the video analytics data mining module 128 are then sent to a third stage rapid miner 312. The third stage rapid miner 312 generates advertising recommendations back to the mobile analytics engine 204 of the mobile device 140.

FIGS. 4A-4D show a process flow diagram for a method of generating targeted advertising. The method 400 is performed by hardware or a combination of hardware and software. For example, the method 400 can be performed by one or more processors reading instructions stored on a tangible, non-transitory, computer-readable medium. The method 400 can also be performed by one or more logic units, such as an Application Specific Integrated Circuit (ASIC), a Field Programmable Gate Array (FPGA), or an arrangement of logic gates implemented in one or more integrated circuits, for example. Throughout the following description, reference may be made to elements of FIG. 1.

FIG. 4A shows the processing performed by the mobile device 140. At block 402, the browser history is accessed and the entire contents of the pages viewed by the user are obtained. At block 404, the text of the pages is tokenized, stop words are removed, and the words are stemmed to a root form. At block, term frequencies are computed and most frequently used terms are extracted to form the word vectors.

At block 408, location information is extracted from the mobile device's geocoder Application Programming Interfaces (APIs). The location data can include address data, feature names, and the like. At block 410, accelerometer data is extracted and classified. Based on the number steps and the speed of the steps, the accelerometer data can be classified into various activity types, including stationary, walking, and running. The time and duration of the activities can also be extracted. At block 412, call log data is extracted and classified as various actions, such as dialing, receiving, text messaging, and the like. The time and duration of calls can also be extracted. The data from blocks 408, 410, and 412 may be referred to herein as user activity data.

At block 414, the user activity data extracted at blocks 408, 410, and 412 is converted to a common format to facilitate data mining. The format may be the ARFF data format, which is usable by the MobileWeka data mining application. The resulting data may represent user activities that have occurred over a specified interval, such as the past day, week, or month. Blocks 408-414 may be repeated periodically to maintain current data.

At block 416, the formatted user activity data from block 414 is processed to identify trends. Such trends may include frequently visited locations, recent physical exercise levels, recent call activity, and the like. The processing at block 416 may be performed using a data mining tool such as MobileWeka.

At block 418, basic user information is extracted from the mobile device, such as configuration information, user information, the unique mobile device identifier, and others. The configuration data from block 418, the trend data from block 416, and the word vector data from block 407 is sent to a communication interface at block 420 to be sent to a Web service 422 of the content management module 130. The operations of the content management module are described further in relation to FIGS. 4B and 4D.

FIG. 4B shows the processing of the video analytics generated by the digital sign 102. At block 424, the local content management module 124 receives one or more rules from the content management module 130. The rules identify an advertisement to display on the digital sign 102. As explained later, the rules received from the content management module 130 are aggregated rules that combine the video analytics rules obtained from the video analytics data mining module 128 with the rules generated by data mining the Web data (FIG. 4C), social media data (FIG. 4D), and mobile device data (FIG. 4A). Using the aggregated rules, the local content management module 124 triggers the rendering of a selected advertisement, for example, by adding the advertisement to a queue of advertisements to be rendered.

At block 426, the advertisement is rendered on the digital sign 102. At block 428, the video analytics data is collected by the cameras 116 on the digital sign 102. At block 430, the video analytics data is processed to generate the audience metrics, which is sent to the video analytics data mining module 128. At block 432, the audience metrics are processed by the video analytics data mining module 128 to generate the video analytics rules. The video analytics rules are sent from the video analytics data mining module 128 to the rules aggregator of the content management module 130. Block 424 to block 434 can be repeated periodically to update the aggregated rules.

FIG. 4C shows the processing performed on the social media data. The processes performed in FIG. 4C may be performed by the social media module 134.

At block 436, data is received from a social media data feed, such as twitter. At block 438, the data from the social media feed is processed by a support vector machine to generate classification data.

At block 440, real time social media trends are received. The social media trends can relate to global social media trends or local social media trends that pertain to a more limited geographical region. The social media trends and classification data from block 438 are sent to another vector machine for testing.

At block 444, the top positive global and local trends are sent to the Web crawling module 132 for further processing and are received at block 462 shown in FIG. 4D.

FIG. 4D shows the processing performed on the social media data, the user interest information from the mobile device, and the Web crawling data. The processes performed in FIG. 4C may be performed by the Web crawling module 134.

At block 446, the user interest data received from the mobile device 140 is forwarded from the Web service 422 of the content management module 130 to the Web crawling module 132. As explained above, this data can include the device configuration data, trend data, and the word vector data. In some examples, the data from the mobile device 140 is formatted in Extensible Markup Language (XML) format. At block 448, the user interest data from the mobile device 140 is parsed into a database.

At block 450, the user interest data from the mobile device 140 is accumulated and processed to correlate browsing keywords in the user interest data with age, gender, and city information. The resulting data is stored to a database. At block 452, the age, gender, and city information is used to train a machine leaning algorithm such as naïve bayes or a nearest neighbor (KNN) algorithm to generate term frequency-inverse document frequency (TF-IDF) data on an age, gender, and city basis. The result of the machine learning algorithm is age/gender/city TF-IDF data that indicates the relative importance of each term extracted from the age, gender, and city data.

At block 454, Web crawling for product reviews is performed. At block 456, clustering is performed on the data collected from the product reviews using a clustering algorithm such as k-means clustering. Each cluster is automatically tagged with a product name according to the product to which the reviews pertain.

At block 456, product TF-IDF data is extracted for each cluster tagged in block 454. The product TF-IDF data includes a list of keywords identified for each cluster. Each keyword is associated with a TF-IDF score. At block 460, the product TF-IDF data is used to train a machine leaning algorithm such as naïve bayes or a nearest neighbor (KNN) algorithm.

At block 462, the user interest data from block 448, the machine learning algorithm, which has been trained with the age/gender/city TF-IDF data from block 452 and the product TF-IDF data from block 460, is run using the user interest data from block 448 and the social media data from block 444 (FIG. 4C) as inputs. The result is a list of one or more product matches between the Web crawling data, the user interest data from the mobile device, and the social media data.

At block 464, the list of product matches is correlated with the advertisements available from the content management module to identify advertisements that are likely to appeal to the user of the mobile device 140. A description of the available advertisements may be received from the content management module 130 at block 466. The output of block 464 is a list of one or more rules generated with input from social media, product reviews, and user interest data from the mobile device. These rules are referred to herein as social media rules.

At block 466, the social media rules are sent to the content management module 130. At block 434, the rules form the video analytics and the social media rules are aggregated to generate the aggregated rules. As explained above, the aggregated rules are sent to the local content media module 124 of the digital sign 102.

It is to be understood that the process flow diagram of FIGS. 4A-D is not intended to indicate that the blocks of the method 400 are to be executed in any particular order, or that all of the blocks are to be included in every case. Further, any number of additional blocks may be included within the method 400, depending on the specific implementation.

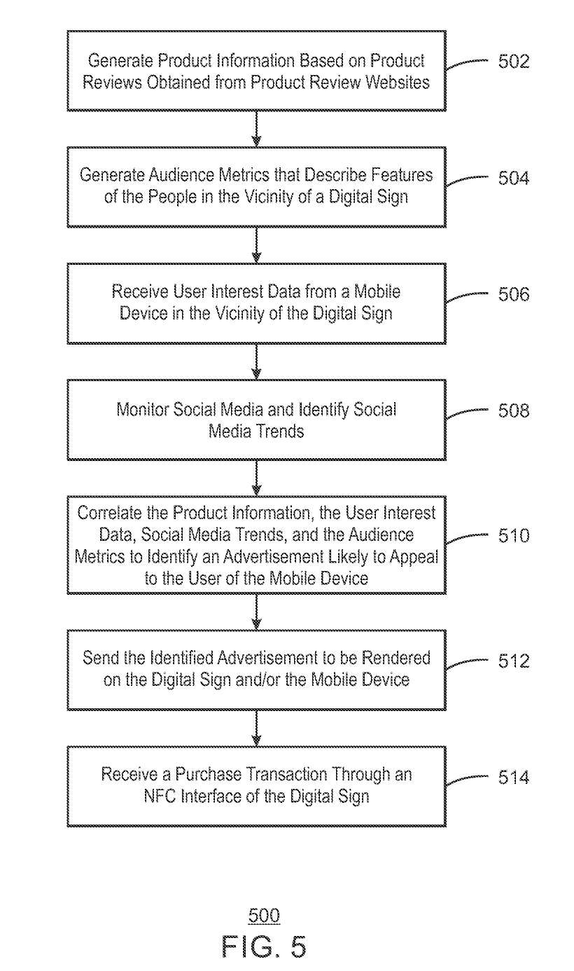

FIG. 5 is a process flow diagram summarizing a method of generating targeted advertising. The method 400 is performed by hardware or a combination of hardware and software. For example, the method 400 can be performed by one or more processors reading instructions stored on a tangible, non-transitory, computer-readable medium. The method 400 can also be performed by one or more logic units, such as an Application Specific Integrated Circuit (ASIC), a Field Programmable Gate Array (FPGA), or an arrangement of logic gates implemented in one or more integrated circuits, for example.

At block 502, product information is generated based on product reviews obtained from product review Websites. The product information can identify various features of a number of products, including positive or negative ratings a product's performance and reliability.

At block 504, audience metrics that describe features of the people in the vicinity of a digital sign are generated. As described above, the audience metrics are obtained by analyzing video captured by one or more cameras coupled to or included in the digital sign, and can include age, gender, and other demographic data.

At block 506, user interest data is received from a mobile device in the vicinity of the digital sign. As described above, the user interest data can be received by the digital sign from a mobile device mining module that resides on the mobile device. The mobile device mining module can generate one or more word vectors that represent user interests. The user interest data is sent to the digital sign anonymously, meaning that none of the information reveals the identity of the user of the mobile device. The user interest data and the audience metrics may be sent from the digital sign to a remote computer system for further processing.

At block 508, a social media feed is monitored and processed to identify social media trends.

At block 510, the product information, the user interest data, social media trends, and the audience metrics are correlated to identify an advertisement likely to appeal to the user of the mobile device.

At block 512, the identified advertisement is sent to the digital sign and/or the mobile device to be rendered.

At block 514, a purchase transaction may optionally be received through an NFC interface of the digital sign.

### Examples

Example 1 is a computer system for identifying targeted advertisements. The computer system includes a Web crawling module that generates product information based on product reviews obtained from product review Websites, and a content management module that receives audience metrics and user interest data from a digital sign. The audience metrics describe features of people in the vicinity of the digital sign, and the user interest data is received from a mobile device in the vicinity of the digital sign. The computer system also includes a data miner to correlate the product information, the user interest data, and the audience metrics to identify an advertisement likely to appeal to the user of the mobile device.

Example 2 includes the computer system of example 1, including or excluding optional features. In this example, the computer system includes a social media mining module that processes a social media feed to identify social media trends. The data miner is to correlate the social media trends with the product information and the user interest data to identify the advertisement.

Example 3 includes the computer system of any one of claims 1 to 2, including or excluding optional features. In this example, a current location of the mobile device is determined by detecting presence of the mobile device through a Near Field Communication (NFC) interface or WiFi interface of the digital sign.

Example 4 includes the computer system of any one of claims 1 to 3, including or excluding optional features. In this example, a user of the mobile device can perform a purchase transaction through an NFC interface of the digital sign, the purchase transaction related to the identified advertisement.

Example 5 includes the computer system of any one of claims 1 to 4, including or excluding optional features. In this example, the user interest data is received by the digital sign from a mobile device mining module that resides on the mobile device and sends the user interest data to the digital sign anonymously. Optionally, the user interest data received from the mobile device mining module comprises a word vector generated from Web pages visited by the user. Optionally, the user interest data received from the mobile device mining module comprises a word vector generated based on user activity data obtained by an accelerometer of the mobile device. Optionally, the user interest data received from the mobile device mining module comprises a word vector generated based on location information obtained from a geolocation application of the mobile device.

Example 6 includes the computer system of any one of claims 1 to 5, including or excluding optional features. In this example, the identified advertisement is sent to the digital sign to be rendered by the digital sign.

Example 7 includes the computer system of any one of claims 1 to 6, including or excluding optional features. In this example, the identified advertisement is sent to the mobile device to be rendered by the mobile device.

Example 8 is a method of identifying targeted advertisements. The method includes generating product information based on product reviews obtained from product review Websites, and receiving audience metrics and user interest data from a digital sign. The audience metrics describe features of people in the vicinity of the digital sign, and the user interest data is received from a mobile device in the vicinity of the digital sign. The method also includes correlating the product information, the user interest data, and the audience metrics to identify an advertisement likely to appeal to the user of the mobile device.

Example 9 includes the method of example 8, including or excluding optional features. In this example, the method includes processing a social media feed to identify social media trends, and correlating the social media trends with the product information and the user interest data to identify the advertisement.

Example 10 includes the method of any one of claims 8 to 9, including or excluding optional features. In this example, the method includes determining a current location of the mobile device by detecting presence of the mobile device through a Near Field Communication (NFC) interface or WiFi interface of the digital sign.

Example 11 includes the method of any one of claims 8 to 10, including or excluding optional features. In this example, the method includes performing a purchase transaction through an NFC interface of the digital sign, the purchase transaction related to the identified advertisement.

Example 12 includes the method of any one of claims 8 to 11, including or excluding optional features. In this example, the user interest data is received by the digital sign from a mobile device mining module that resides on the mobile device and sends the user interest data to the digital sign anonymously. Optionally, the user interest data received from the mobile device mining module comprises a word vector generated from Web pages visited by the user. Optionally, the user interest data received from the mobile device mining module comprises a word vector generated based on user activity data obtained by an accelerometer of the mobile device. Optionally, the user interest data received from the mobile device mining module comprises a word vector generated based on location information obtained from a geolocation application of the mobile device.

Example 13 includes the method of any one of claims 8 to 12, including or excluding optional features. In this example, the method includes sending the identified advertisement to the digital sign to be rendered by the digital sign.

Example 14 includes the method of any one of claims 8 to 13, including or excluding optional features. In this example, the method includes sending the identified advertisement to the mobile device to be rendered by the mobile device.

Example 15 is a tangible, non-transitory, computer-readable medium comprising instructions that, when executed by a processor, direct the processor to identify a targeted advertisement. The computer-readable medium includes instructions that direct the processor to generate product information based on product reviews obtained from product review Websites, and receive audience metrics and user interest data from a digital sign. The audience metrics describe features of people in the vicinity of the digital sign, and the user interest data is received from a mobile device in the vicinity of the digital sign. The computer-readable medium also includes instructions that direct the processor to correlate the product information, the user interest data, and the audience metrics to identify an advertisement likely to appeal to the user of the mobile device.

Example 16 includes the computer-readable medium of example 15, including or excluding optional features. In this example, the computer-readable medium includes instructions to direct the processor to process a social media feed to identify social media trends, and correlate the social media trends with the product information and the user interest data to identify the advertisement.

Example 17 includes the computer-readable medium of any one of claims 15 to 16, including or excluding optional features. In this example, the user interest data is received by the digital sign from a mobile device mining module that resides on the mobile device and sends the user interest data to the digital sign anonymously. Optionally, the user interest data received from the mobile device mining module comprises a word vector generated from Web pages visited by the user. Optionally, the user interest data received from the mobile device mining module comprises a word vector generated based on user activity data obtained by an accelerometer of the mobile device. Optionally, the user interest data received from the mobile device mining module comprises a word vector generated based on location information obtained from a geolocation application of the mobile device.

Example 18 includes the computer-readable medium of any one of claims 15 to 17, including or excluding optional features. In this example, the computer-readable medium includes sending the identified advertisement to the digital sign to be rendered by the digital sign.

Example 19 includes the computer-readable medium of any one of claims 15 to 18, including or excluding optional features. In this example, the computer-readable medium includes sending the identified advertisement to the mobile device to be rendered by the mobile device.

Example 20 is a computer system. The computer system includes logic to generate product information based on product reviews obtained from product review Websites, and logic to receive audience metrics and user interest data from a digital sign. The audience metrics describe features of people in the vicinity of the digital sign, and the user interest data is received from a mobile device in the vicinity of the digital sign. The computer system also includes logic to correlate the product information, the user interest data, and the audience metrics to identify an advertisement likely to appeal to the user of the mobile device.

Example 21 includes the computer system of example 20, including or excluding optional features. In this example, the computer system includes logic to process a social media feed to identify social media trends, and logic to correlate the social media trends with the product information and the user interest data to identify the advertisement.

Example 22 includes the computer system of any one of claims 20 to 21, including or excluding optional features. In this example, the computer system includes logic to determine a current location of the mobile device by detecting presence of the mobile device through a Near Field Communication (NFC) interface or WiFi interface of the digital sign.

Example 23 includes the computer system of any one of claims 20 to 22, including or excluding optional features. In this example, the computer system includes logic to perform a purchase transaction through an NFC interface of the digital sign, the purchase transaction related to the identified advertisement.

Example 24 includes the computer system of any one of claims 20 to 23, including or excluding optional features. In this example, the user interest data is received by the digital sign from a mobile device mining module that resides on the mobile device and sends the user interest data to the digital sign anonymously. Optionally, the user interest data received from the mobile device mining module comprises a word vector generated from Web pages visited by the user. Optionally, the user interest data received from the mobile device mining module comprises a word vector generated based on user activity data obtained by an accelerometer of the mobile device. Optionally, the user interest data received from the mobile device mining module comprises a word vector generated based on location information obtained from a geolocation application of the mobile device.

Example 25 includes the computer system of any one of claims 20 to 24, including or excluding optional features. In this example, the computer system includes logic to send the identified advertisement to the digital sign to be rendered by the digital sign.

Example 26 includes the computer system of any one of claims 20 to 25, including or excluding optional features. In this example, the computer system includes logic to send the identified advertisement to the mobile device to be rendered by the mobile device.

Example 27 is an apparatus for identifying targeted advertisements. The apparatus includes means for generating product information based on product reviews obtained from product review Websites, and means for receiving audience metrics and user interest data from a digital sign. The audience metrics describe features of people in the vicinity of the digital sign, and the user interest data is received from a mobile device in the vicinity of the digital sign. The apparatus also includes means for correlating the product information, the user interest data, and the audience metrics to identify an advertisement likely to appeal to the user of the mobile device.

Example 28 includes the apparatus of example 27, including or excluding optional features. In this example, the apparatus includes means for processing a social media feed to identify social media trends, and means for correlating the social media trends with the product information and the user interest data to identify the advertisement.

Example 29 includes the apparatus of any one of claims 27 to 28, including or excluding optional features. In this example, the apparatus includes means for determining a current location of the mobile device by detecting presence of the mobile device through a Near Field Communication (NFC) interface or WiFi interface of the digital sign.

Example 30 includes the apparatus of any one of claims 27 to 29, including or excluding optional features. In this example, the apparatus includes means for performing a purchase transaction through an NFC interface of the digital sign, the purchase transaction related to the identified advertisement.

Example 31 includes the apparatus of any one of claims 27 to 30, including or excluding optional features. In this example, the user interest data is received by the digital sign from a mobile device mining module that resides on the mobile device and sends the user interest data to the digital sign anonymously. Optionally, the user interest data received from the mobile device mining module comprises a word vector generated from Web pages visited by the user. Optionally, the user interest data received from the mobile device mining module comprises a word vector generated based on user activity data obtained by an accelerometer of the mobile device. Optionally, the user interest data received from the mobile device mining module comprises a word vector generated based on location information obtained from a geolocation application of the mobile device.

Example 32 includes the apparatus of any one of claims 27 to 31, including or excluding optional features. In this example, the apparatus includes means for sending the identified advertisement to the digital sign to be rendered by the digital sign.

Example 33 includes the apparatus of any one of claims 27 to 32, including or excluding optional features. In this example, the apparatus includes means for sending the identified advertisement to the mobile device to be rendered by the mobile device.

In the above description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a computer-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, described herein. The various appearances “an embodiment,” “one embodiment,” or “some embodiments” are not necessarily all referring to the same embodiments.

Not all components, features, structures, or characteristics described and illustrated herein are to be included in a particular embodiment or embodiments in every case. If the specification states a component, feature, structure, or characteristic “may”, “might”, “can” or “could” be included, for example, that particular component, feature, structure, or characteristic may not be included in every case. If the specification or claims refer to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein may not be arranged in the particular way illustrated and described herein. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A computer system for identifying targeted advertisements, comprising:
a Web crawling module that generates product information based on product reviews obtained from product review Websites;
a content management module that receives audience metrics and user interest data from a digital sign, wherein the audience metrics describe features of people in the vicinity of the digital sign, and wherein the user interest data is received from a mobile device in the vicinity of the digital sign; and
a data miner to correlate the product information, the user interest data, and the audience metrics to identify an advertisement likely to appeal to the user of the mobile device.

2. The computer system of claim 1, comprising a social media mining module that processes a social media feed to identify social media trends, the data miner to correlate the social media trends with the product information and the user interest data to identify the advertisement.

3. The computer system of claim 1, wherein a current location of the mobile device is determined by detecting presence of the mobile device through a Near Field Communication (NFC) interface or WiFi interface of the digital sign.

4. The computer system of claim 1, wherein a user of the mobile device can perform a purchase transaction through an NFC interface of the digital sign, the purchase transaction related to the identified advertisement.

5. The computer system of claim 1, wherein the user interest data is received by the digital sign from a mobile device mining module that resides on the mobile device and sends the user interest data to the digital sign anonymously.

6. The computer system of claim 5, wherein the user interest data received from the mobile device mining module comprises a word vector generated from Web pages visited by the user.

7. The computer system of claim 5, wherein the user interest data received from the mobile device mining module comprises a word vector generated based on user activity data obtained by an accelerometer of the mobile device.

8. The computer system of claim 5, wherein the user interest data received from the mobile device mining module comprises a word vector generated based on location information obtained from a geolocation application of the mobile device.

9. The computer system of claim 1, wherein the identified advertisement is sent to the digital sign to be rendered by the digital sign.

10. The computer system of claim 1, wherein the identified advertisement is sent to the mobile device to be rendered by the mobile device.

11. A method of identifying targeted advertisements, comprising:
generating product information based on product reviews obtained from product review Websites;
receiving audience metrics and user interest data from a digital sign, wherein the audience metrics describe features of people in the vicinity of the digital sign, and wherein the user interest data is received from a mobile device in the vicinity of the digital sign; and
correlating the product information, the user interest data, and the audience metrics to identify an advertisement likely to appeal to the user of the mobile device.

12. The method of claim 11, comprising processing a social media feed to identify social media trends, and correlating the social media trends with the product information and the user interest data to identify the advertisement.

13. The method of claim 11, comprising determining a current location of the mobile device by detecting presence of the mobile device through a Near Field Communication (NFC) interface or WiFi interface of the digital sign.

14. The method of claim 11, performing a purchase transaction through an NFC interface of the digital sign, the purchase transaction related to the identified advertisement.

15. The method of claim 11, wherein the user interest data is received by the digital sign from a mobile device mining module that resides on the mobile device and sends the user interest data to the digital sign anonymously.

16. The method of claim 15, wherein the user interest data received from the mobile device mining module comprises a word vector generated from Web pages visited by the user.

17. The method of claim 15, wherein the user interest data received from the mobile device mining module comprises a word vector generated based on user activity data obtained by an accelerometer of the mobile device.

18. The method of claim 15, wherein the user interest data received from the mobile device mining module comprises a word vector generated based on location information obtained from a geolocation application of the mobile device.

19. The method of claim 11, comprising sending the identified advertisement to the digital sign to be rendered by the digital sign.

20. The method of claim 11, comprising sending the identified advertisement to the mobile device to be rendered by the mobile device.

21. A tangible, non-transitory, computer-readable medium comprising instructions that, when executed by a processor, direct the processor to identify a targeted advertisement, the instructions to direct the processor to:
generate product information based on product reviews obtained from product review Websites;
receive audience metrics and user interest data from a digital sign, wherein the audience metrics describe features of people in the vicinity of the digital sign, and wherein the user interest data is received from a mobile device in the vicinity of the digital sign; and
correlate the product information, the user interest data, and the audience metrics to identify an advertisement likely to appeal to the user of the mobile device.

22. The computer-readable medium of claim 21, comprising instructions to direct the processor to process a social media feed to identify social media trends, and correlate the social media trends with the product information and the user interest data to identify the advertisement.

23. The computer-readable medium of claim 21, wherein the user interest data is received by the digital sign from a mobile device mining module that resides on the mobile device and sends the user interest data to the digital sign anonymously.

24. The computer-readable medium of claim 21, comprising sending the identified advertisement to the digital sign to be rendered by the digital sign.

25. The computer-readable medium of claim 21, comprising sending the identified advertisement to the mobile device to be rendered by the mobile device.
